(19) United States
(12) Patent Application Publication
(10) Pub. No.: US 2025/0187810 A1
(43) Pub. Date: Jun. 12, 2025

(54) Expandable Sheet with Shifted Arrangements of Slits

(71) Applicant: 3M INNOVATIVE PROPERTIES COMPANY, St. Paul, MN (US)

(72) Inventor: Thomas R. Corrigan, St. Paul, MN (US)

(21) Appl. No.: 18/993,080

(22) PCT Filed: Jul. 20, 2023
(86) PCT No.: PCT/IB2023/057418

§ 371 Date: Jan. 10, 2025

Related U.S. Application Data
(60) Provisional application No. 63/391,230, filed on Jul. 21, 2022.
(60) Provisional application No. 63/432,863, filed on Dec. 15, 2022.

(51) Int. Cl. B65D 81/05; B31D 5/00

(52) U.S. Cl. CPC B65D 81/05; B31D 5/0065; B31D 2205/0058

(57) ABSTRACT

An expandable sheet includes a substrate of sheet material defining the major surface and a plurality of slits formed in the substrate in a slit pattern defining a width along the cross axis and a length along the expansion axis. The slit pattern includes at least a first region and a second region, each comprising at least two staggered rows of the slits defining an arrangement of pattern features. At least one of the regions has a different arrangement of pattern features than another region. The slits are configured to expand in response to a minimum tension applied to the substrate in the expansion axis to provide an expanded configuration with folded walls.

The present disclosure relates to expandable sheets and, in particular, to expandable sheets with shifted arrangements of slits.

Tension-activated, expandable sheets are sheets, for example of paper or plastic, that are cut with a slit pattern enabling them to be expanded when tension is applied along a tensioning axis of the sheet. An exemplary tension-activated, expandable sheet is SCOTCH™ CUSHION LOCK™ protective wrap available from 3M Company (St. Paul, Minnesota, USA), a paper-based, tension-activated, expandable sheet. Upon application of tension to expand such a sheet, portions of the sheet rotate to create an interlocking folded-wall structure that absorbs energy and can be used, for example, to cushion and protect objects during shipping.

### SUMMARY

In one aspect, an expandable sheet defines an expansion axis and a cross axis along a major surface. The expandable sheet includes a substrate of sheet material defining the major surface. The expandable sheet also includes a plurality of slits formed in the substrate in a slit pattern defining a width along the cross axis and a length along the expansion axis including at least a first region and a second region. Each region extends across the width. Each region includes at least two staggered rows of the slits defining an arrangement of pattern features, where the first region defines a first arrangement of pattern features and the second region defines a second arrangement of pattern features different than the first arrangement. The slits are configured to expand in response to a minimum tension applied to the substrate in the expansion axis to provide an expanded configuration.

In one aspect, a roll includes the expandable sheet.

In one aspect, a rotary die includes cutting surfaces configured to form the expandable sheet.

### BRIEF DESCRIPTION OF VIEWS OF THE DRAWINGS

To easily identify the discussion of any particular element or act, the most significant digit or digits in a reference number refer to the figure number in which that element is first introduced.

FIG. 1A and FIG. 1B are photographs of perspective end views of an existing expandable sheet in the form of a roll.

FIG. 2 is a top view of an expandable sheet of the present disclosure.

FIG. 3 is an elevation view of an apparatus usable to form the expandable sheet of FIG. 2.

FIG. 4 is a top view of a slit usable with the expandable sheet of FIG. 2.

FIG. 5 is a top view of a portion of a slit pattern usable with the expandable sheet of FIG. 2.

FIG. 6 is an expanded view of the circular portion indicated as “516” in FIG. 5.

FIG. 7 is an expanded view of the circular portion indicated as “518” in FIG. 5.

FIG. 8 is an expanded view of the circular portion indicated as “520” in FIG. 5.

FIG. 9 is an expanded view of the circular portion indicated as “520” in FIG. 5.

FIG. 10 is a profile view of an expanded sheet using the slit pattern of FIG. 5 in a first expanded configuration.

FIG. 11 is a profile view of the expanded sheet of FIG. 10 in a second expanded configuration.

FIG. 12 is a photograph of an end view of expandable slit paper of the present disclosure in roll form.

FIG. 13 is a top view of a slit pattern usable with the expandable sheet of FIG. 2 having a phase shifted pattern feature.

FIG. 14 is a top view of a slit pattern usable with the expandable sheet of FIG. 2 having an orientation shifted pattern feature.

FIG. 15 is a top view of a slit pattern usable with the expandable sheet of FIG. 2 having a phase shifted pattern feature.

### DESCRIPTION

The present disclosure relates to an expandable sheet having slits in a slit pattern having a first region and a second region defining an arrangement of pattern features different than the first arrangement. In general, shifting of the slit pattern allows for a visually consistent product with a pattern that rarely, if ever, matches the adjacent pattern when is the sheet is wound onto a roll, which may facilitate smooth winding into and unwinding from a roll form of the expandable sheet. In some embodiments, the expandable sheet may be a phase-shifted, tension-activated, expandable sheet. In some embodiments, slit patterns include regions that have oscillations that are phase shifted so that they cannot grip as easily with adjacent layers.

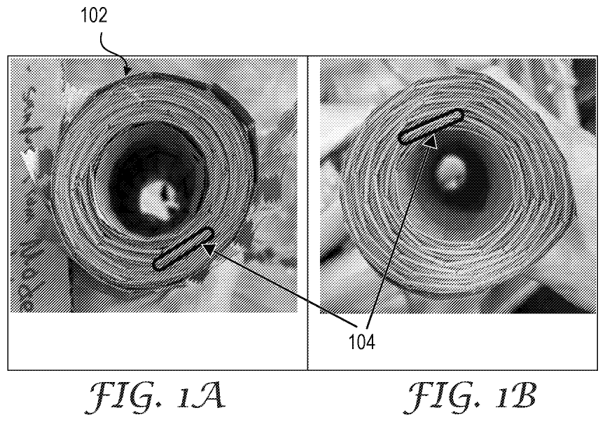

The loftiness and interlocking nature of tension-activated, expandable sheets may be enhanced by the presence of “fingers” or oscillations on the cross-web portion of the pattern. As the expandable sheet is being wound onto a roll, the diameter of the roll increases slowly. When the arrangement of slits used for expandable sheets is a slit pattern, a portion of the sheet may overlap with one or more adjacent layers having the same pattern frequently when the roll circumference increases by the period of the repeat. When the same part of the pattern overlaps in adjacent layers, those layers tend to grip onto each other and form a block of material instead of smoothly winding onto the roll. FIG. 1A and FIG. 1B show two photographs that show different views of an expandable sheet 102 wound into a roll having blocks of material 104 corresponding to regions of the pattern that have gripped onto adjacent layers. It appears that about 5 layers have gripped together in these images.

This sticking of multiple adjacent layers is particularly problematic at smaller diameters and when the winding is looser, but is also present even on large tightly wound rolls. On larger rolls, it appears more as a “picking” effect where the material does not come off the roll as easily. This can lead to the material tearing while being deployed from a dispenser for example.

Briefly, a solution to this and other problems can lie in using a slit pattern with different arrangements of slits. For example, a slit pattern that changes and is therefore out of phase with adjacent patterns when the paper is wound on a roll could mitigate such problems.

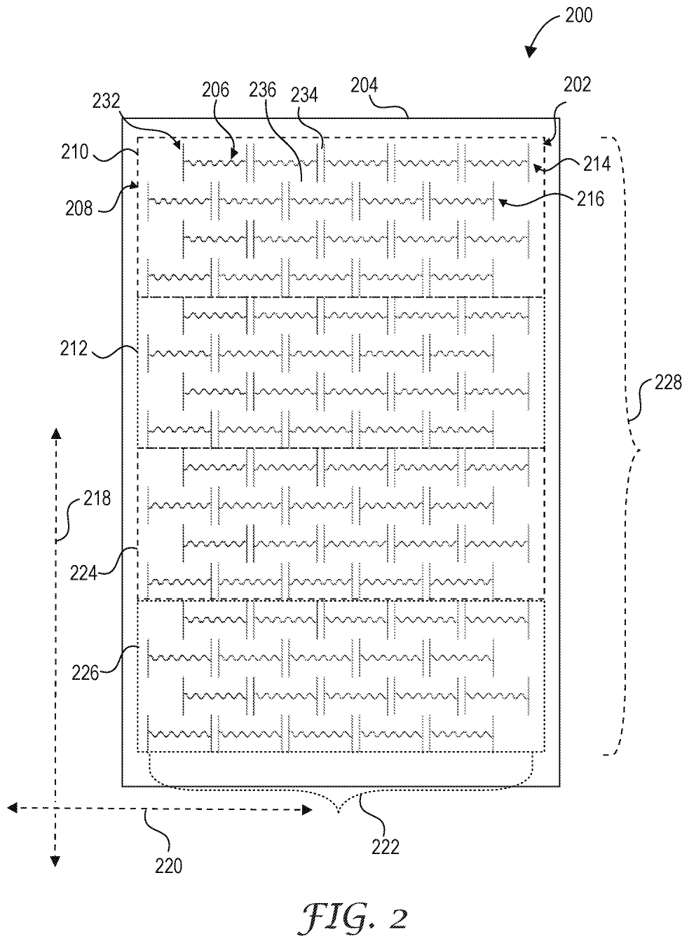

FIG. 2 shows an expandable sheet 200 having a slit pattern 202 according to the present disclosure. The expandable sheet 200 defines an expansion axis 218 (or vertical axis) and a cross axis 220 (or horizontal axis) orthogonal to the expansion axis along a major surface. The expandable sheet 200 includes a substrate 204 of sheet material defining the major surface and a plurality of slits 206 formed, or defined, in the substrate along the major surface. The slit pattern 202 corresponds to the arrangement of slits 206 along the major surface. In some embodiments, the slit pattern 202 may be a repeating slit pattern, which repeats one or more times along the expansion axis 218.

The slit pattern 202 defines a width 222 along the cross axis 220 and a length 228 along the expansion axis 218. The slit pattern 202 may be a repeating slit pattern 202, for example, when the expandable sheet 200 has a length greater than the length 228 of the slit pattern 202. As illustrated, only a portion of the slit pattern 202 of the expandable sheet 200 is shown for illustrative purposes. In general, the slit pattern 202 extends to the edges of the expandable sheet 200 (e.g., across its entire width and along its entire length, or repeated to extend along its entire length) to facilitate deployment and expansion of the expandable sheet 200 into an expandable configuration.

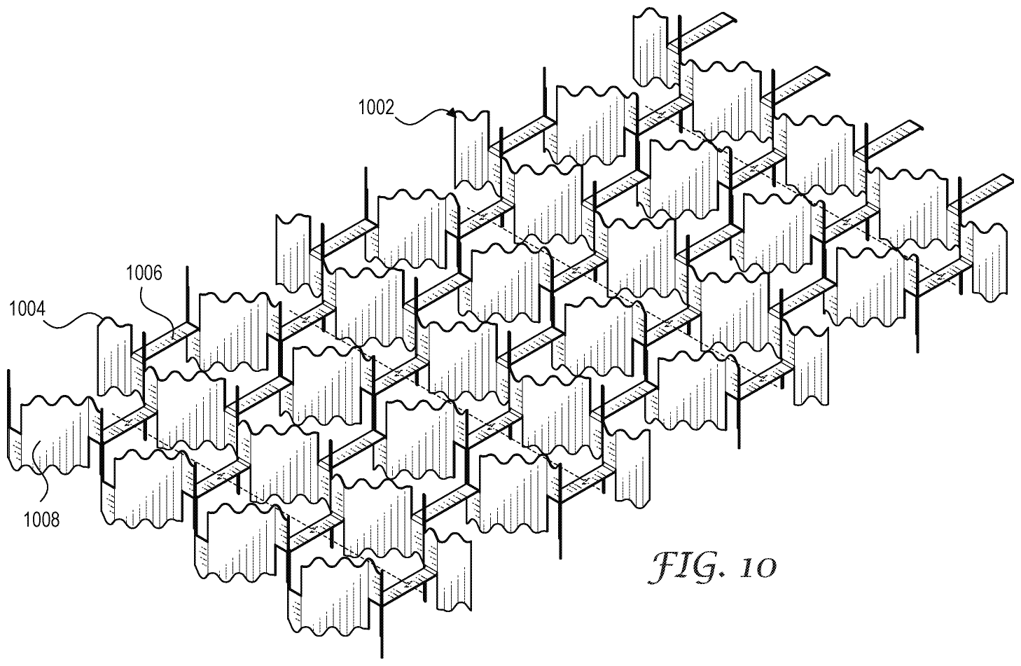

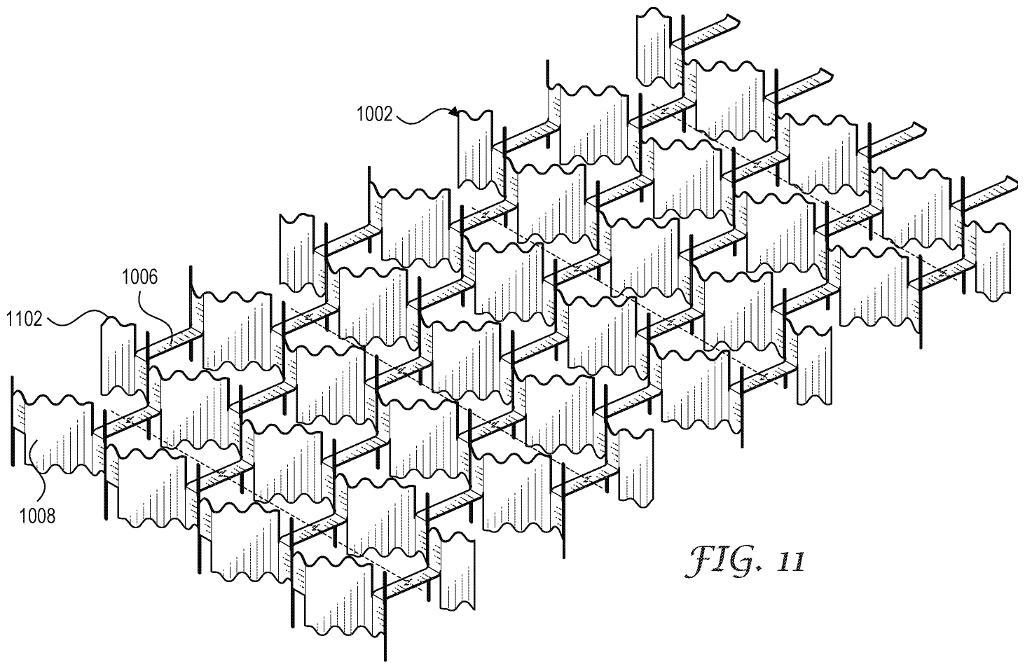

The slits 206 are configured to expand in response to a minimum tension applied to the substrate 204 in the expansion axis 218 to provide an expanded configuration, which may form folded walls. A folded wall may be formed of portion 236 of sheet material between nearby slits 206 in adjacent rows 232. Between adjacent slits 206 in the same row is a beam 234 of material, which may not rotate when expanded. In particular, when the expandable sheet 200 is initially in an unexpanded configuration (a substantially flat sheet) then tension-activated (pulled along the expansion axis 218), portions of the substrate 204 may move upward and downward from the substantially two-dimensional (2D) major surface and become a three-dimensional (3D) article as described herein in more detail (see FIG. 10 and FIG. 11).

The slit pattern 202 is defined to include multiple regions 208, in particular at least a first region 210 and a second region 212. In the illustrated embodiment, the slit pattern 202 also includes a third region 224 and a fourth region 226. Each of the regions 208 are defined to extend across the width 222 of the slit pattern 202.

Each of the regions 208 includes at least two staggered rows 232 of the slits 206. Each of the rows 232 of slits 206 is substantially parallel to one another, and each of the rows 232 includes multiple slits 206. Each of the rows 232 may be substantially parallel to the cross axis 220. One of more of the regions 208 may include additional rows 232, which may also be staggered. Each region may have two, three, four, or more rows of staggered slits 206. In some embodiments, at least one region comprises three or more staggered rows 232 of slits 206. In the illustrated embodiment, each region includes four rows 232 of staggered slits 206.

As used herein, the term “staggered row” refers to the locations of substantially all the slits in a given row being out of phase, or phase offset, by a set amount or a minimum distance along the cross axis 220 when compared to corresponding slits in a directly adjacent row. In the illustrated embodiment, the adjacent rows 232 are out of phase by one half of the horizontal pitch (for example, as measured by the geometric center-to-center distance) between the slits 206.

Each of the arrangements of a region may be described as defining the location and orientation of various pattern features. In general, the slit pattern 202 includes at least one arrangement that is different than at least one other arrangement. In the illustrated embodiment, the first region 210 defines a first arrangement of pattern features and the second region 212 defines a second arrangement of pattern features different than the first arrangement. Further, the slit pattern 202 may include additional regions with the same or different arrangement. In the illustrated embodiment, the slit pattern 202 includes a third region 224 and a fourth region 226. Each of these additional regions another arrangement different than the first arrangement, the second arrangement, or both.

As used herein, the term “pattern features” refers to a slit or of a slit feature along the major surface. As used herein, the term “slit feature” refers to a segment, a segment intersection, or an end point of a slit. The term “shifted pattern feature” of an arrangement refers to a shifted location or orientation of a slit or a slit feature compared to a corresponding slit or slit feature in another arrangement. The term “shifted slit” refers to a shift in the location or orientation of an entire slit. The term “shifted slit feature” refers to a shift in the location or orientation of a slit feature in a slit. Different arrangements may be compared by overlaying one region on top of another region and identifying how one or more slits or slit features have shifted.

In the illustrated embodiment, the slit pattern 202 defines at least a second arrangement of the second region 212 has one or more shifted pattern features compared to a first arrangement of the first region 210. The other arrangements may have one or more shifted pattern features compared to the first arrangement, the second arrangement, or both. In the illustrated embodiment, the third region 224 has a third arrangement different than the first and second arrangements, and the fourth region 226 has a fourth arrangement different than the first, second, and third arrangements.

The shifted pattern features may be implemented in various ways in a slit pattern. Each slit in at least one row of an arrangement may have at least one of the shifted pattern features compared to another arrangement. In particular, in the illustrated embodiment, each slit 206 in at least one row of the second arrangement has at least one of the shifted pattern features compared to the first arrangement. Such shifted pattern features may also be applied to other arrangements, such as the third arrangement and the fourth arrangement. In some embodiments, each slit 206 of the second arrangement may have at least one of the shifted pattern features. In the illustrated embodiment, each slit 206 of the second, third, and fourth arrangements has at least one of the shifted pattern features compared to the first arrangement, and also compared to one another.

A shift in the location of the pattern features may be embodied in various ways. In some embodiments, a shifted pattern feature corresponds to a phase shift, in particular, in the location of a slit or slit feature compared to a corresponding slit or slit feature in another arrangement. A phase shift of a shifted pattern feature may be measured relative to a width of each slit or the horizontal pitch between each slit. In some embodiments, the phase shift may be greater than or equal to 1, 2, 3, 4, 5, 10, 15, 20, or 25 percent of the width of the slit corresponding to the shifted pattern feature. In some embodiments, the phase shift may be less than or equal to 33, 25, 20, 15, 10, 5, 4, 3, 2, or 1 percent of the width of the slit corresponding to the shifted pattern feature.

In some embodiments, the phase shift is along the cross axis 220 (e.g., in a horizontal direction). A phase shift along the cross axis 220 may be used, for example, when at least one slit 206 in each region includes a segment extending at least partially along the expansion axis 218. In the illustrated embodiment, the second arrangement includes slit features in its slits 206 that are phase shifted along the cross axis 220 compared to corresponding slit features in the first arrangement while the location and orientation of the slits 206 are not shifted. The phase shift of slit features without shifting slits themselves is also shown in FIG. 5.

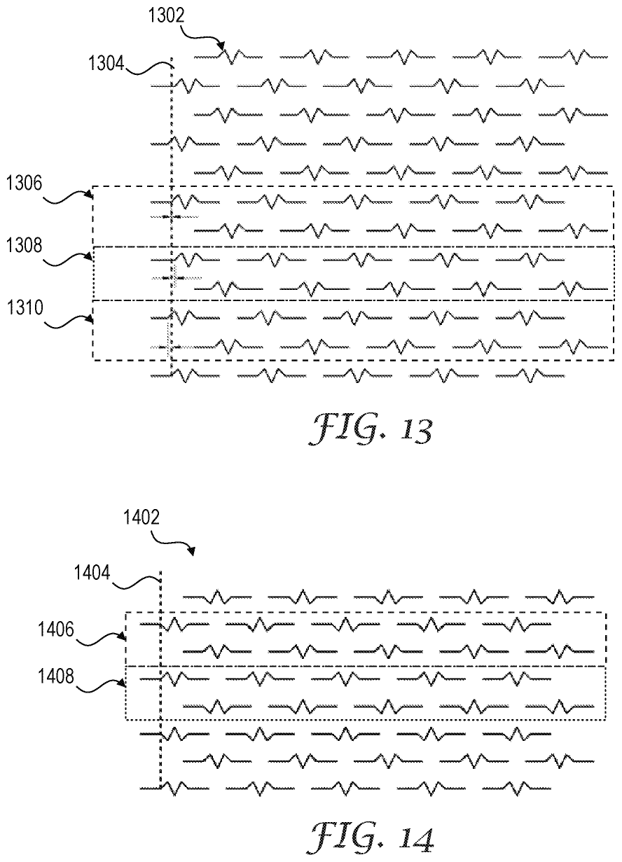

A shift in the orientation of the pattern features may be embodied in various ways. In some embodiments, a shifted pattern feature corresponds to an inversion in a slit or slit feature (see FIG. 14).

As used herein, the term “slit” refers to a narrow cut through the article forming at least one line or segment, which may be straight or curved, or described as linear or non-linear, having at least two terminal ends. Slits described herein are discrete, meaning that individual slits do not intersect other slits. A slit is generally not a cut-out, where a “cut-out” is defined as a surface area of the sheet that is removed from the sheet when a slit intersects itself. However, in practice, many forming techniques result in the removal of some surface area of the sheet that is not considered a “cut-out” for the purposes of the present application. In particular, many cutting technologies produce a “kerf”, or a cut having some physical width. For example, a laser cutter will ablate some surface area of the sheet to create the slit, a router will cut away some surface area of the material to create the slit, and even crush cutting creates some deformation on the edges of the material that forms a physical gap across the surface area of the material. Furthermore, molding techniques require material between opposing faces of the slit, creating a gap or kerf at the slit. In various embodiments, the gap or kerf of the slit will be less than or equal to the thickness of the material. For example, a slit pattern cut into paper that is 0.007″ (approximately 18 mm) thick might have slits with a gap that is approximately 0.007″ or less. However, it is understood that the width of the slit could be increased to a factor that is many times larger than the thickness of the material and be consistent with the technology disclosed herein.

Slits can be characterized as “simple slits” or “compound slits,” where a “simple slit” is defined as having exactly two terminal ends and a “compound slit” has more than two terminal ends.

Slit patterns can also be characterized as single slit patterns or multi slit patterns. The term “single slit pattern” refers to a pattern of individual slits that form individual rows each extending across the sheet transversely along the cross axis, where the rows form a slit pattern of individual rows along the axial length of the sheet, and the pattern of slits in each row is different than the pattern of slits in the directly adjacent rows. For example, the slits in one row may be staggered, or axially offset or out of phase, with the slits in the directly adjacent rows. A “multi slit pattern” refers to a pattern of individual slits that form a first set of transversely adjacent rows, where the individual slits within the first set of adjacent rows are transversely aligned. A second set of adjacent rows may be staggered, or axially offset or out of phase, with the first set of rows. Multi slit patterns may include double slit patterns, triple slit patterns, quadruple slit patterns, etc.

In the illustrated embodiment, the slit pattern 202 includes multiple separate regions of slits 206. Each region includes multiple staggered rows 232 of slits 206. In FIG. 2, each region has four rows of slits 206, but the number can differ depending on the size of the pattern and intended size of the roll. Each slit 206 in the slit pattern 202 contains a first segment that is roughly sinusoidal or oscillatory and runs generally in a transverse direction. The slits 206 also include one or more second segments that are generally linear and run along the expansion axis 218 (which may also be described as being approximately in a longitudinal or axial direction). Each region differs in that the first (sinusoidal) segment of the slit 206 of one region is out of phase with the first segment of the other regions. For example, the four rows 232 in the first region 210 feature a first (sinusoidal) segment that intersects a second (linear) segment near a maximum of the sinusoid, whereas the next four rows in the second region 212 feature a first (sinusoidal) segment that intersects a second (linear) segment near a minimum of the sinusoid. These shifted slit features provide a difference in the first arrangement of the first region 210 and the second arrangement of the second region 212. The same principal of different portions of the sinusoidal pattern intersecting the second (linear) segment of the slits 206 applies to the other regions as well.

The substrate 204 of sheet material may be formed of various suitable materials. Some exemplary materials into which the slit patterns described herein can be formed include, for example, paper (including cardboard, corrugated paper, coated or uncoated paper, kraft paper, cotton bond, recycled paper, virgin paper, extensible paper); plastic; woven and non-woven materials and/or fabrics; elastic materials (including rubber such as natural rubber, synthetic rubber, nitrile rubber, silicone rubber, urethane rubbers, chloroprene rubber, Ethylene Vinyl Acetate or EVA rubber); inelastic materials (including polyethylene and polycarbonate); polyesters; acrylics; and polysulfones. The article can be, for example, a material, sheet, film, or any similar construction. As used herein, the term “extensible” refers to materials that are able to elongate (e.g., 20% or less) under tension without slits.

Examples of thermoplastic materials that can be used include one or more of polyolefins (e.g., polyethylene (high density polyethylene (HDPE), medium density polyethylene (MDPE), low density polyethylene (LDPE), linear low density polyethylene (LLDPE)), metallocene polyethylene, and the like, and combinations thereof), polypropylene (e.g., atactic and syndiotactic polypropylene)), polyamides (e.g. nylon), polyurethane, polyacetal (such as Delrin), polyacrylates, and polyesters (such as polyethylene terephthalate (PET), polyethylene terephthalate glycol (PETG), and aliphatic polyesters such as polylactic acid), fluoroplastics (such as THV from 3M company, St. Paul, MN, US), and combinations thereof. Examples of thermoset materials can include one or more of polyurethanes, silicones, epoxies, melamine, phenol-formaldehyde resin, and combinations thereof. Examples of biodegradable polymers can include one or more of polylactic acid (PLA), polyglycolic acid (PGA), poly(caprolactone), copolymers of lactide and glycolide, polyethylene succinate), polyhydroxybutyrate, and combinations thereof.

“Paper” as used herein refers to woven or non-woven sheet-shaped products or fabrics (which may be folded, and may be of various thicknesses) made from cellulose (particularly fibers of cellulose, (whether naturally or artificially derived)) or otherwise derivable from the pulp of plant sources such as wood, corn, grass, rice, and the like. Paper includes products made from both traditional and non-traditional paper making processes, as well as materials of the type described above that have other types of fibers embedded in the sheet, for example, reinforcement fibers. Paper also includes extensible papers made through various processes including creping, double-roll compaction, CLUPAK compaction, the EXPANDA double-roll process or any other process or additive to increase the extensibility of the paper. Paper may have coatings on the sheet or on the fibers themselves. Examples of non-traditional products that are “paper” within the context of this disclosure include the material available under the trade designation TRINGA from PAPTIC (Espoo, Finland), and sheet forms of the material available under the trade designation SULAPAC from SULAPAC (Helsinki, Finland).

The material in which the single slit pattern is formed can be of any desired thickness. In some embodiments, the material has a thickness between about 0.001 inch (0.025 mm) and about 5 inches (127 mm). In some embodiments, the material has a thickness between about 0.01 inch (0.25 mm) and about 2 inches (51 mm). In some embodiments, the material has a thickness between about 0.1 inch (2.5 mm) and about 1 inch (25.4 mm). In some embodiments, the thickness is greater than 0.001 inch (0.025 mm), or 0.01 inch (0.25 mm), or 0.05 inch (1.3 mm), or 0.1 inch (2.5 mm), or 0.5 inch (13 mm), or 1 inch (25 mm), or 1.5 inches (38 mm), or 2 inches (51 mm), or 2.5 inches (64 mm), or 3 inches (76 mm). In some embodiments, the thickness is less than 5 inches (127 mm) or 4 inches (101 mm), or 3 inches (76 mm), or 2 inches (51 mm), or 1 inch (25 mm), or 0.5 inch (13 mm), or 0.25 inch (6.3 mm), or 0.1 inch (2.5 mm).

In some embodiments, where the material is paper, the thickness is between about 0.003 inch (0.076 mm) and about 0.010 inch (0.25 mm). In some embodiments where the material is plastic, the thickness is between about 0.005 inch (0.13 mm) and about 0.125 inch (3.2 mm).

In some embodiments, the slit or cut pattern extends substantially to one or more of the edges of the sheet, film, or material. In some embodiments, this allows the material to be of unlimited length and also to be deployed by tension, particularly when made with non-extensible or less-extensible materials. The amount of edge material is the area of material surrounding and not including the single slit pattern. In some embodiments, the amount of edge material, or down-web border, can be defined as the width of the rectangle whose long axis is parallel to the expansion axis and can be drawn on the substrate without overlapping or touching any slits. In some embodiments, the amount of edge material is less than 0.010 inch (0.25 mm) or less than 0.001 inch (0.025 mm). In some embodiments, the width of the down-web border is less than 0.010 inch (0.25 mm) or less than 0.001 inch (0.025 mm). In some embodiments, the amount of edge material is less than 5 times the thickness of the substrate. In some embodiments, the width of the down-web border is less than 5 times the thickness of the substrate.

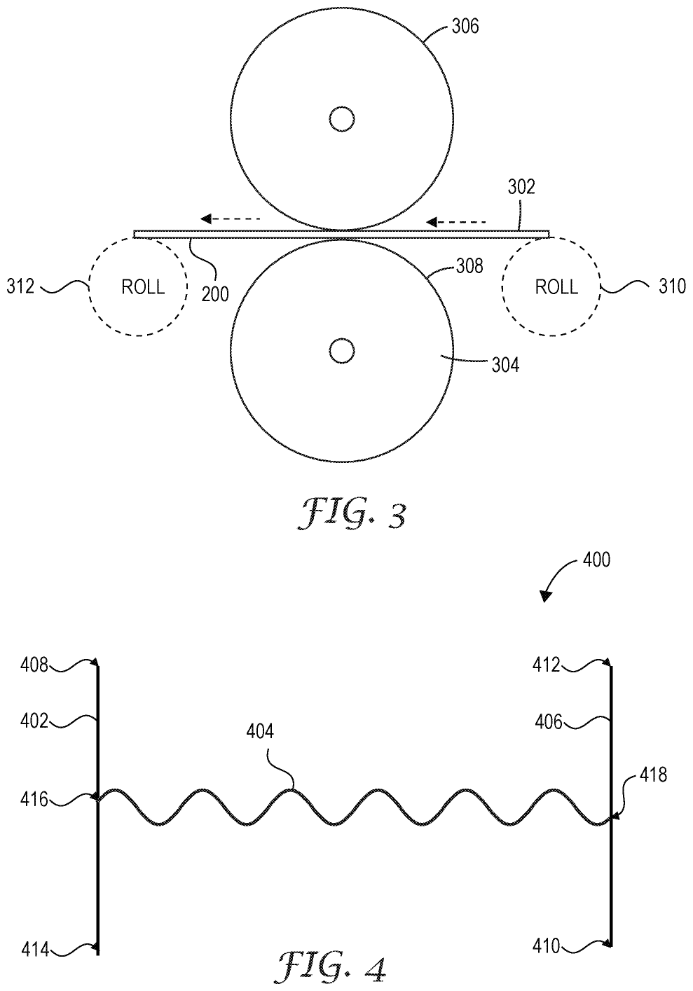

FIG. 3 shows an example of paper or other sheet material 302 being formed into an expandable sheet, such as the expandable sheet 200 (FIG. 2). In general, a slit pattern and an expandable sheet can be made in a number of different ways. For example, the slit pattern can be formed by extrusion, molding, laser cutting, water jetting, machining, stereolithography or other 3D printing techniques, laser ablation, photolithography, chemical etching, rotary die cutting, stamping, other suitable negative or positive processing techniques, or combinations thereof. In particular, in the illustrated embodiment, paper or other sheet material 302 is fed into a nip consisting of a rotary die 304 and an anvil 306. In this example, the sheet material 302 may be stored in the form of a roll 310 where the material is rolled around a central axis that may include or may omit a central core and then unrolled to be fed into the nip. The rotary die 304 has cutting surfaces 308 on it that correspond to a slit pattern, such as the slit pattern 202 (FIG. 2), to be cut into the sheet material 302. The rotary die 304 cuts through the sheet material 302 and forms and arrangement of the slits 206 along the major surface representing one or more of the slit pattern 202. In particular, the length 228 of the slit pattern 202 may correspond with the circumference of the rotary die 304 such that multiple revolutions of the rotary die 304 form a repeating slit pattern in the expandable sheet 200 along the expansion axis 218. The expandable sheet 200 may then be stored in the form of a roll 312 where the material is rolled around a central axis that may include or may omit a central core and then unrolled to be expanded by tension activation. The same process can be used with a flat die and flat anvil.

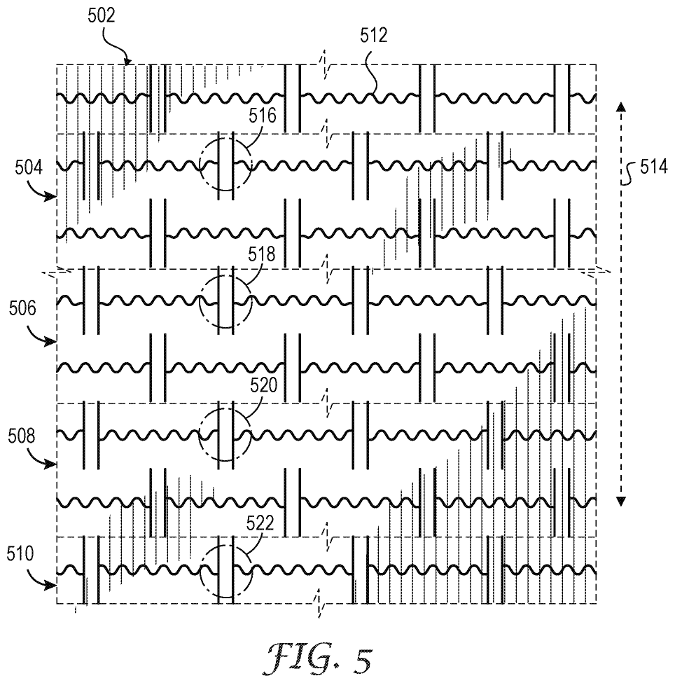

FIG. 4 shows one example of a slit 400 usable in the slit pattern 202 (FIG. 2). In general, each slit includes one or more of a segment, a segment intersection, a terminal end, or any combination of these. As illustrated, the slit 400 includes a straight or linear segment 402 having two opposing terminal ends 408, 414 and a linear segment 406 having two opposing terminal ends 412, 410. The slit 400 also includes a curved or non-linear segment 404 extending between and connecting the segment 402 and the segment 406 at a first segment intersection 416 and a second segment intersection 418, respectively. The segment 404 does not include of the four terminal ends of the slit 400.

FIG. 5 shows another example of a slit pattern according to the present disclosure, which may be used with the expandable sheet 200 (FIG. 2). The slit pattern 502 is similar to the slit pattern 202 (FIG. 2). In the illustrated embodiment, the slit pattern 502 includes multiple separate regions of slits 512, including first region 504, second region 506, third region 508, and fourth region 510. Each region includes multiple staggered rows of slits 512. Each of the slits 512 in the slit pattern 502 contains a first segment that is roughly sinusoidal or oscillatory and runs generally in a transverse direction. The slits 512 also include one or more second segments that are generally linear and run along the expansion axis 514 (which may also be described as being approximately in a longitudinal or axial direction). Each region differs in that the first (sinusoidal) segment of each of the slits 512 of one region is out of phase with the first (sinusoidal) segment of the other regions. For example, the two rows in the first region 504 feature a first segment that intersects the second (linear) segment near a maximum of the sinusoid, whereas the next two rows in the second region 506 feature a first (sinusoidal) segment that intersects the second (linear) segment near a minimum of the sinusoid. These shifted slit features provide a difference in the first arrangement of the first region 504 and the second arrangement of the second region 506. The same principal of different portions of the sinusoidal pattern intersecting the second (linear) segment of the slits 512 applies to the other regions as well.

In some embodiments, at least one of the shifted pattern features in a slit pattern 202 corresponds to a shifted slit feature in one of the slits without shifting at least one other slit feature in the same slit. In both the slit pattern 202 and the slit pattern 502, the first (sinusoidal) segment of each slit is shifted, while the other (linear) segments are not shifted.

In some embodiments, each of the slits may be described as having a same shape, except at least one of the shifted pattern features corresponds to a shifted slit feature compared to a corresponding slit feature in the first arrangement. For example, the segments of the slits may have the same segment shapes but one of the segments may be shifted. In both the slit pattern 202 and the slit pattern 502, the first (sinusoidal) segment of each slit is shifted, while the other (linear) segments are not shifted.

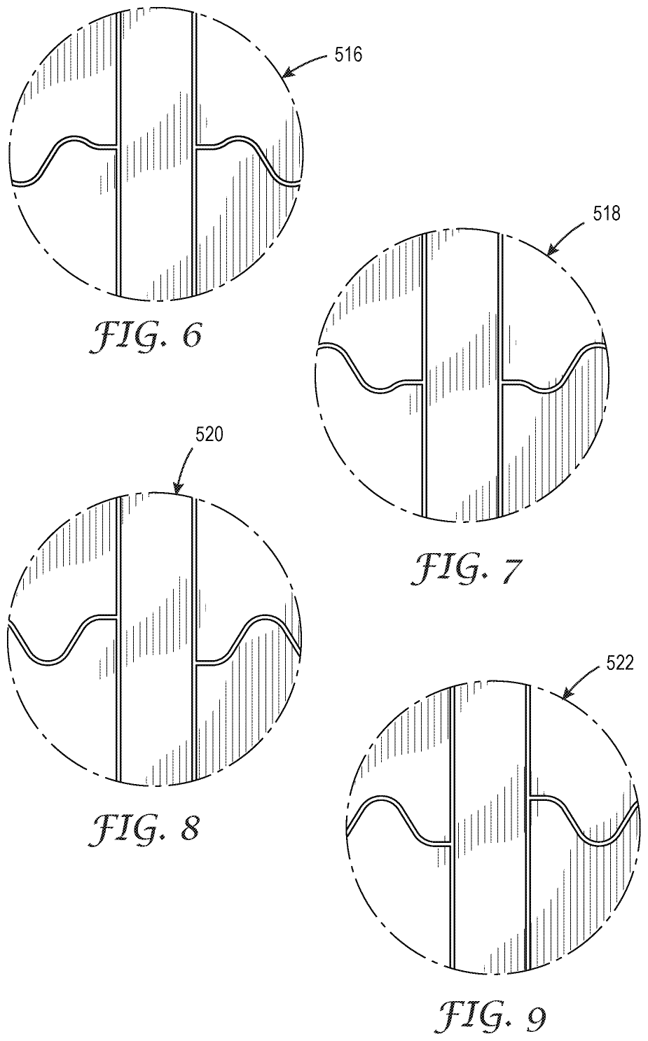

This is further illustrated in FIG. 6 to FIG. 9, which correspond to circular portions 516, 518, 520, 522 shown in FIG. 5, respectively, where the first (sinusoidal) segment of each slit intersects the one or more second (linear) segments of the slit. FIG. 6 to FIG. 9 show four separate ways in which the oscillatory first segment of the slit can intersect the one or more vertical segments of the slit. Generally, the oscillatory segments of the slit are phase shifted among the separate patterns depicted in FIG. 2 and FIG. 5. Because the oscillations with the four different phase shifts do not match the path of any of the other oscillations, they do not tend to stick to each other when wound to form a roll.

When a sheet containing the slit pattern 202 or the slit pattern 502 is subjected to a tension force in an axial direction, the material expands to form a three-dimensional pattern. FIG. 10 shows an expandable sheet 1002 having the slit pattern 502 (FIG. 5) in a first expanded configuration 1004, which may also be described as an alternating or up-down variant where adjacent folded wall sections have rotated the opposite direction. FIG. 11 shows the same expandable sheet 1002 (FIG. 10) but in a second expanded configuration 1102, which may also be described as a parallel or up-up variant where all the folded wall sections have rotated the same direction. It is possible, and likely, that both variants will exist within a single expanded sheet unless it is expanded carefully. It is also possible that a single folded wall can change from rotating one direction to the other along its length. All these variations are natural and generally due to the randomness of the materials and the application of tension to expand the sheet.

As can be seen in FIG. 10 and FIG. 11, the expandable sheet 1002 in an expanded configuration may provide a non-rotating beam 1006 and folded walls 1008 of sheet material. When exposed to tension, a beam (such as beam 234 of FIG. 2) between adjacent slits in a row becomes a non-rotating beam. Each folded wall 1008 may be described as being bounded at least partially by two adjacent slits in different rows. In the illustrated embodiment, each folded wall is bounded at least partially by two segments from each of the two adjacent slits.

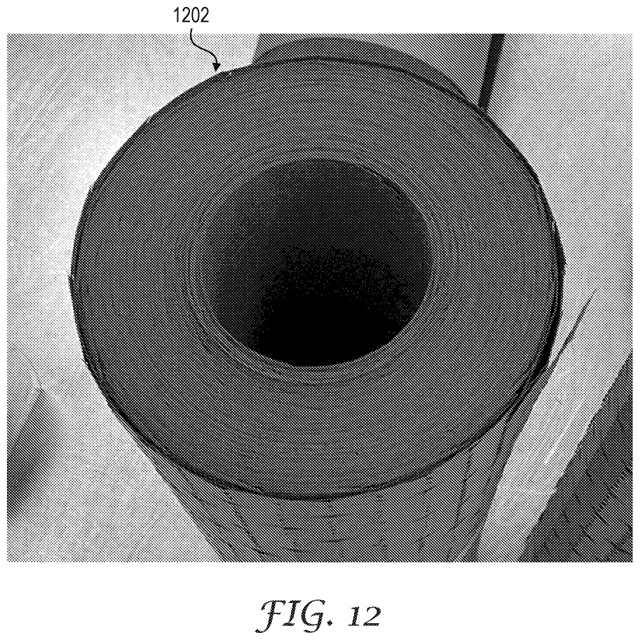

FIG. 12 shows a paper expandable sheet 102 featuring a phase-shifted slit pattern according to the present disclosure wound into the form of a roll. The phase-shifted slit pattern may facilitate the roll of the expandable sheet 1202 being wound more smoothly in comparison to the roll of the expandable sheet 102 shown in FIG. 1A and FIG. 1B.

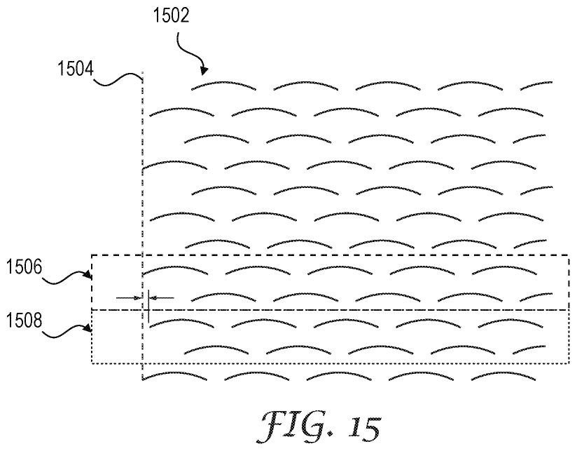

Various slit patterns of the present disclosure, such as compound slit patterns, provide folded walls in the expanded configuration of the expandable sheet. Other slit patterns of the present disclosure, such as simple slit patterns, provide open 3D structures other than folded walls in the expanded configuration of the expandable sheet, such as shown in FIG. 13, FIG. 14, and FIG. 15.

FIG. 13 shows another example of a slit pattern 1302 according to the present disclosure. In the illustrated embodiment, in slit pattern 1302, each of the slits has a same shape, and at least one of the shifted pattern features represents a shifted slit feature. In particular, the slit features in each region are phase shifted relative to slit features in another region. In the first region 1306, a first slit in the first row has a segment intersection aligned with the vertical line 1304, which may be parallel to the corresponding expansion axis. In the second region 1306, a first slit in the first row has a segment intersection phase shifted in a first horizontal direction (right), which may be parallel to the corresponding cross axis, compared to the arrangement of the first region 1306. In the third region 1310, a first slit in the first row has a segment intersection phase shifted in a second horizontal direction (left) opposite to the first direction.

FIG. 14 shows another example of a slit pattern 1402 according to the present disclosure. In the illustrated embodiment, in slit pattern 1402, at least one of the shifted pattern features represents an inversion in the orientation of a slit or slit feature compared to a corresponding slit or slit feature in another arrangement. In particular, the slits in each adjacent region are inverted across the expansion axis or the cross axis. In the first region 1406, each slit in the first row has one maximum and two minima along the vertical line 1404, which may be parallel to the corresponding expansion axis, and each slit in the second row has two maxima and one minimum. In the second region 1408, each slit in the first row has two maxima and one minimum, and each slit in the second row has one maximum and two minima.

FIG. 15 shows yet another example of a slit pattern 1502 according to the present disclosure. Slit pattern 1502 is similar to slit pattern 1302. In the illustrated embodiment, in slit pattern 1502, each of the slits has a same shape, and at least one of the shifted pattern features represents a shifted slit. In particular, the slits in each region are phase shifted relative to slits in another region. In the first region 1506, a first slit in the first row has a terminal end aligned with the vertical line 1504, which may be parallel to the corresponding expansion axis. In the second region 1508, a first slit in the first row has a terminal end phase shifted in a horizontal direction (right), which may be parallel to the corresponding cross axis, compared to the arrangement of the first region 1506.

In some embodiments (not shown), the shifted pattern features may include varying heights in cross-web slabs between rows of slits, which phase shift the location of slits along the expansion axis. Cross-web slabs can be defined as rectangular regions with a rectangle whose long axis is perpendicular to the expansion axis and whose width is some finite number and can be drawn on the substrate without overlapping or touching any slits. In some embodiments, cross-web slabs of any width may already exist within the article as an integral part of the pattern. In some embodiments, cross-web slabs of any width may be added to the ends of a finite length article to make the article easier to deploy. In some embodiments, cross-web slabs of any width may be added intermittently to a continuously patterned article.

In some embodiments, the distance between the farthest spaced terminal ends of a single slit (also referred to as the slit length) is between about 0.25 inch (6.35 mm) long and about 3 inches (76 mm) long, or between about 0.5 inch (13 mm) and about 2 inches (51 mm), or between about 1 inch (25 mm) and about 1.5 inches (38 mm). In some embodiments, the farthest distance between terminal ends of a single slit (also referred to as slit length) is between 50 times the substrate thickness and 1000 times the substrate thickness, or between 100 and 500 times the substrate thickness. In some embodiments, the slit length is less than 1000 times the substrate thickness, or less than 900 times, or less than 800 times, or less than 700 times, or less than 600 times, or less than 500 times, or less than 400 times, or less than 500 times, or less than 200 times, or less than 100 times the substrate thickness. In some embodiments, the slit length is greater than 50 times the substrate thickness, or greater than 100 times, or greater than 200 times, or greater than 500 times, or greater than 400 times, or greater than 500 times, or greater than 600 times, or greater than 700 times, or greater than 800 times, or greater than 900 times the substrate thickness.

The articles and materials described herein can be used in various ways. In one embodiment, the two-dimensional sheet, material, or article has tension applied along the expansion axis, which causes the slits to form the openings and/or flaps and/or motions described herein. In some embodiments, the tension is applied by hand or with a machine.

The present disclosure describes articles that begin as a flat sheet but deploy into a three-dimensional construction upon the application of force/tension. In some embodiments, such constructions form energy absorbing structures. The patterns, articles, and constructions described herein have a large number of potential uses, at least some of which are described herein.

One exemplary use is to protect objects for shipping or storage. As stated above, existing shipping materials have a variety of drawbacks including, for example, they occupy too much space when stored before use (e.g., bubble wrap, packing peanuts) and thus increase the cost of shipping; they require special equipment to manufacture (e.g., inflatable air bags); they are not always effective (e.g., crumpled paper); and/or they are not widely recyclable (e.g., bubble wrap, packing peanuts, inflatable airbags). The tension-activated, expanding films, sheets, and articles described herein can be used to protect items during shipping without any of the above drawbacks. When made of sustainable materials, the articles described herein are effective and sustainable. Because the articles described herein are flat when manufactured, shipped, sold, and stored and only become three-dimensional when activated with tension/force by the user, these articles are more effective and efficient at making the best use of storage space and minimizing shipping/transit/packaging costs. Retailers and users can use relatively little space to house a product that will expand to 10 or 20 or 30 or 40 or more times its original size. Further, the articles described herein are simple and highly intuitive for use. The user merely pulls the product off the roll or takes flat sheets of product, applies tension across the article along the expansion axis (which can be done by hand or with a machine), and then wraps the product around an item to be shipped. In many embodiments, no tape is needed because the interlocking features enable the product to interlock with another layer of itself.

In some embodiments, the slit patterns described herein create packaging materials and/or cushioning films that provide advantages over the existing offerings. For example, in some embodiments, the packaging materials and/or cushioning films of the present disclosure provide enhanced cushioning or product protection. In some embodiments, the packaging materials and/or cushioning films of the present disclosure provide similar or enhanced cushioning or product protection when compared to the existing offerings but are recyclable and/or more sustainable or environmentally friendly than existing offerings. In some embodiments, the packaging materials and/or cushioning films of the present disclosure provide similar or enhanced cushioning or product protection when compared to the existing offerings but can be expanded and wrapped around an item to be shipped. Constructions that hold their shape once tension is applied can be preferred because they may eliminate the need for tape to hold the material in place for many applications.

Thus, various embodiments of an expandable sheet with shifted arrangements of slits are disclosed. Other features and combinations of features within the scope of this disclosure may be readily apparent to one skilled in the art having the benefit of the figures, descriptions, and claims.

Terms related to orientation, such as “vertical,” “horizontal,” “axial,” “longitudinal,” “transverse,” and “end,” are used to describe relative positions of features and are not meant to limit the absolute orientation of the embodiments contemplated.

As used herein, the term “configured to” may be used interchangeably with the terms “adapted to” or “structured to” unless the content of this disclosure clearly dictates otherwise.

Unless otherwise indicated, all numbers expressing feature distances, sizes, amounts, and physical properties used in the specification and claims may be understood as being modified either by the term “exactly” or “about.”

The singular forms “a,” “an,” and “the” encompass embodiments having plural referents unless its context clearly dictates otherwise.

The term “or” is generally employed in its inclusive sense, for example, to mean “and/or” unless the context clearly dictates otherwise. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. An expandable sheet defining an expansion axis and a cross axis along a major surface, the expandable sheet comprising:
a substrate of sheet material defining the major surface; and
a plurality of slits formed in the substrate in a slit pattern defining a width along the cross axis and a length along the expansion axis comprising at least a first region and a second region, each region extending across the width, each region comprising at least two staggered rows of the slits defining an arrangement of pattern features, wherein the first region defines a first arrangement of pattern features and the second region defines a second arrangement of pattern features different than the first arrangement,
wherein the slits are configured to expand in response to a minimum tension applied to the substrate in the expansion axis to provide an expanded configuration.

2. The expandable sheet of claim 1, wherein the second arrangement has one or more shifted pattern features compared to the first arrangement, wherein each shifted pattern feature corresponds to a shifted location or orientation of a slit or a slit feature compared to a corresponding slit or slit feature the first arrangement.

3. The expandable sheet of claim 2, wherein each slit feature corresponds to a segment, a segment intersection, or an end point of a slit.

4. The expandable sheet of claim 2, wherein each slit in at least one row of the second arrangement has at least one of the shifted pattern features.

5. The expandable sheet of claim 4, wherein each slit of the second arrangement has at least one of the shifted pattern features.

6. The expandable sheet of claim 2, wherein at least one of the shifted pattern features corresponds to a phase shift in the location of a slit or slit feature compared to a corresponding slit or slit feature in the first arrangement.

7. The expandable sheet of claim 6, wherein the phase shift is along the cross axis, and at least one slit in each region comprises a segment extending at least partially along the expansion axis.

8. The expandable sheet of claim 2, wherein at least one of the shifted pattern features corresponds to an inversion in the orientation of a slit or slit feature compared to a corresponding slit or slit feature in the first arrangement.

9. The expandable sheet of claim 2, wherein at least one of the shifted pattern features corresponds to a shifted slit feature in one of the slits without shifting at least one other slit feature in the same slit.

10. The expandable sheet of claim 2, wherein each of the slits has a same shape, except at least one of the shifted pattern features corresponds to a shifted slit feature compared to a corresponding slit feature in the first arrangement.

11. The expandable sheet of claim 2, wherein each of the slits has a same shape, and at least one of the shifted pattern features corresponds to a shifted slit.

12. The expandable sheet of claim 1, wherein the slit pattern comprises additional regions, each defining another arrangement different than the first arrangement, the second arrangement, or both.

13. The expandable sheet of claim 1, wherein the expanded configuration has folded walls.

14. A roll comprising the expandable sheet according to claim 1.

15. A rotary die comprising cutting surfaces configured to form the expandable sheet according to claim 1.
